(19) United States
(12) Patent Application Publication
(10) Pub. No.: US 2002/0084567 A1
(43) Pub. Date: Jul. 4, 2002

(54) Method for providing an inserter system with a variable input speed at startup

(76) Inventor: Russell W. Holbrook, Southbury, CT (US)

Correspondence Address: Christopher J. Capelli, Pitney Bowes Inc., Intellectual Property and, Technology Law Dept., 35 Waterview Drive, P.O. Box 3000, Shelton, CT, 06484, US

(21) Appl. No.: 09/750,207

(22) Filed: Dec. 28, 2000

(51) Int. Cl. B41L 43/14

(52) U.S. Cl. 270/32

(57) ABSTRACT

A method for operating an input sheet feeder coupled to an inserter system including the steps of providing an inserter system having a control system coupled to a sheet input station, wherein the sheet input station is coupled to a supply of continuous formed web and receiving a start command in the sheet input station to start operation of the sheet input station. The sheet input station then starts at an initial speed that is a fraction of its full operational speed and gradually increases the operational speed of the sheet input station from said initial speed to said full speed over a predetermined amount of time.

### FIELD OF THE INVENTION

The present invention relates generally to devices for cutting sheets from a continuous web, and more particularly, to a method for initially varying the operating speed of a sheet cutter at startup.

### BACKGROUND OF THE INVENTION

Multi-station document inserting systems generally include a plurality of various stations that are configured for specific applications. Typically, such inserting systems, also known as console inserting machines, are manufactured to perform operations customized for a particular customer. Such machines are known in the art and are generally used by organizations, which produce a large volume of mailings where the content of each mail piece may vary.

For instance, inserter systems are used by organizations such as banks, insurance companies and utility companies for producing a large volume of specific mailings where the contents of each mail item are directed to a particular addressee. Additionally, other organizations, such as direct mailers, use inserts for producing a large volume of generic mailings where the contents of each mail item are substantially identical for each addressee. Examples of such inserter systems are the 8 series and 9 series inserter systems available from Pitney Bowes Inc. of Stamford, Conn.

In many respects the typical inserter system resembles a manufacturing assembly line. Sheets and other raw materials (other sheets, enclosures, and envelopes) enter the inserter system as inputs. Then, a plurality of different modules or workstations in the inserter system work cooperatively to process the sheets until a finished mailpiece is produced. The exact configuration of each inserter system depends upon the needs of each particular customer or installation.

For example, a typical inserter system includes a plurality of serially arranged stations including a sheet feeding station, a folding station, a plurality of insert feeder stations, an envelope feeder and insertion station and an output station for collecting the assembled mailpieces. As is conventional, the sheet feeder feeds one or a plurality of sheets to an accumulating station, which collects the fed sheets into a predefined collation packet. This collation is then preferably advanced to a folding station for folding the collation. Thereafter, the serially arranged insert feeder stations sequentially feed the necessary documents onto a transport deck at each insert station as the folded collation arrives at the respective station to form a precisely collated stack of documents which is transported to the envelope feeder-insert station where the stack is inserted into the envelope. The finished envelope is then conveyed to an output station for distribution into the mail stream. A typical modem inserter system also includes a control system to synchronize the operation of the overall inserter system to ensure that the mailpieces are properly assembled.

One of the most important features of a modem inserter system concerns the reliability of providing a constant input of sheets into the inserter system. Since a sheet cutter is often the input module of the inserter system responsible for providing an input of sheets to the chassis of the inserter system, it is then of significant importance that the cutter provides a supply of sheets at a reliable high rate.

A typical sheet cutter incorporates a sheet feeder which feeds a continuous web from either a roll or fan-folded stack into the sheet cutter. The web is driven into the sheet cutter by its sheet feeder via sprocket holes located on one or both sides of the web. In essence, there are two principal components to the force imparted on a paper web from its supply position to it's cutting position in the sheet cutter. The first are forces created by the acceleration of the web mass by the conveyor/tractor drive of the sheet cutter. The other predominant force is created by aerodynamic effects, forces generated from wind resistance against the motion of the web. When accelerations are high, the later forces can be enough to break the web at a perforation or cause the tractor pinfeed holes to tear. When high throughput (e.g., in excess of 20,000 cycles per hour) is desired, the acceleration forces on the tractor pin holes and the aerodynamically induced forces on the web become a limiting factor to the obtainable cycle rate. It is further noted that these forces on the web are significantly greater at system startup when the web comes to motion from rest. Once the feed “rhythm” is established, the “dances” in air and creates a “buffer” loop of web in the air to absorb acceleration induced shocks to the web. However, before this feed rhythm is established, the web is extremely vulnerable to breakage due to the initial startup forces of the sheet cutter as explained above.

Thus, it is an object of the present invention to provide an improved sheet cutter that operates to reliably cut sheets without subjecting the web to breakage during the initial startup of the sheet cutter.

### SUMMARY OF THE INVENTION

Accordingly, the present invention relates to a method for operating an input sheet feeder coupled to an inserter system at a variable speed in which during startup of the sheet feeder it gradually increases its operational speed to its full operational speed. This method includes the steps of providing an inserter system having a control system coupled to a sheet input station, wherein the sheet input station is coupled to a supply of continuous formed web and receiving a start command in the sheet input station to start operation of the sheet input station. The sheet input station then starts at an initial speed that is a fraction of its full operational speed and gradually increases the operational speed of the sheet input station from said initial speed to said full speed over a predetermined amount of time.

### BRIEF DESCRIPTION OF THE DRAWINGS

The above and other objects and advantages of the present invention will become more readily apparent upon consideration of the following detailed description, taken in conjunction with accompanying drawings, in which like reference characters refer to like parts throughout the drawings and in which:

FIG. 1 is a block diagram of a document inserting system in which the present invention is incorporated;

FIG. 2 is a planar view of a web being fed into the cutter module of FIG. 1;

FIGS. 3 is a flow chart depicting prior art steps for starting operation of the sheet cutter of FIG. 2; and

FIG. 4 is a flow chart depicting the steps for starting operation of the sheet cutter of FIG. 2 in accordance with the present invention.

### DETAILED DESCRIPTION OF THE PREFERRED EMBODIMENT

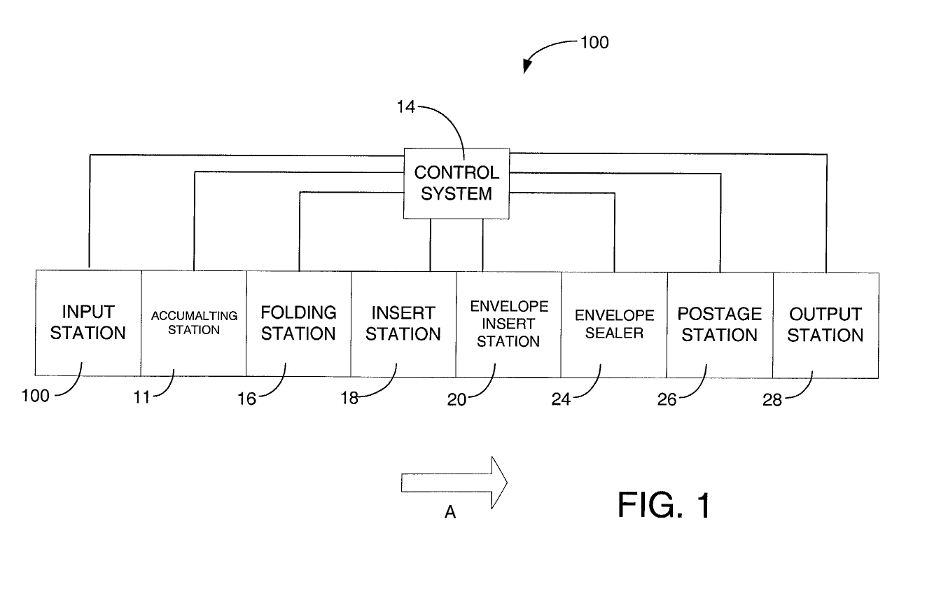

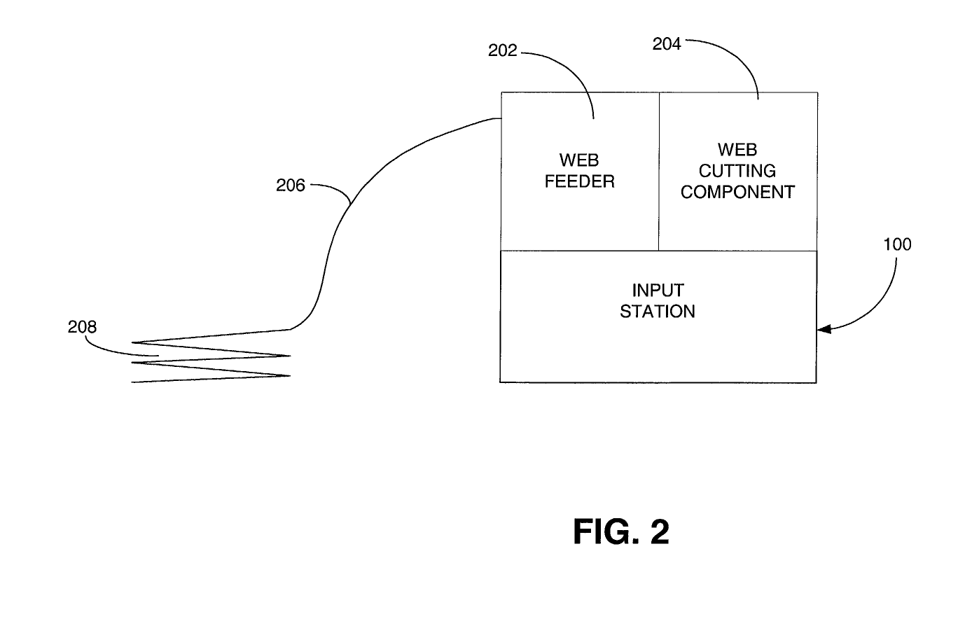

In describing the preferred embodiment of the present invention, reference is made to the drawings, wherein there is seen in FIG. 1 a schematic of a typical document inserting system, generally designated 10. A brief description of this typical inserting system 10 is given to set forth the operating environment for the present invention sheet feeder, generally designated 100 in FIGS. 1 and 2.

In the following description, numerous paper handling stations implemented in a typically prior art inserter system 10 are set forth to provide a brief understanding of a typical inserter system. It is of course apparent to one skilled in the art that the present invention may be practiced without the specific details in regards to each of these paper-handling stations of inserter system 10.

As will be described in greater detail below, document inserter system 10 preferably includes an input station 100 that feeds paper sheets from a paper web to an accumulating station 11 that accumulates the sheets of paper in collation packets. Preferably, only a single sheet of a collation is coded (the control document), which coded information enables the control system 14 of inserter system 10 to control the processing of documents in the various stations of the mass mailing inserter system. The code can comprise a bar code, UPC code or the like.

Essentially, input station 100 feeds sheets in a paper path, as indicated by arrow “a,” along what is commonly termed the “deck” of inserter system 10. After sheets are accumulated into collations by an accumulating station 11, the collations are folded in folding station 16 and the folded collations are then conveyed to a insert feeder station 18. An example of such an accumulating station 11 can be found in U.S. Pat. No. 5,083,769, which is hereby incorporated by reference. It is to be appreciated that a typical inserter system 10 includes a plurality of insert feeder stations, but for clarity of illustration only a single insert feeder 18 is shown.

Insert feeder station 18 is operational to convey an insert (e.g., an advertisement) from a supply tray to the main deck of inserter system 10 so as to be nested with the aforesaid sheet collation conveying along the main deck. The sheet collation, along with the nested insert(s), are next conveyed to an envelope insertion station 20 that is operative to insert the collation into an open envelope.

After the envelope exits the envelope insertion station 20, it then preferably conveys to an envelope sealer station 24 for sealing. After the envelope is sealed, it is then preferably conveyed to a postage station 26 having at least one postage meter for affixing appropriate postage to the envelope. Finally, the envelope is preferably conveyed to an output station 28 that collects the envelopes for postal distribution.

As previously mentioned, inserter system 10 includes the input station 100 which causes sheets to be inputted into the inserter system 10. Typically, the input station 100 is associated with a supply of sheets 208 (FIG. 2), which sheet supply consists of continuously coupled sheets, otherwise known of in the art as a web supply. This web supply 208 can be either a continuous spool of sheets or may be sheets formed in a fan folded format.

In either event, the web is driven into input station 100, via sprocket holes located on one or both sides of the web. It is to be appreciated, and as illustrated in FIG. 2, the input station 100 includes a web feeder component 202 and a web cutting component 204. The web feeder component is operational to fed a web 206 from its supply 208 (e.g., via sprocket holes) into the web cutting component 204. The web cutting component 204, in turn, is operational to separate the web 206 into individual sheets for further processing in the inserter system 10. As is well known in the art, this can be accomplished through either a cutting component (e.g., cutting blade) or sheet burster.

In operation, and as stated above, when the web 206 is fed from the web supply 208 into the web feeder 202 of the input station 100, there are two principal components to the force imparted on a paper web 206 from its supply position 208 to it's cutting position in the input station 100. The first are forces created by the acceleration of the web mass by the conveyor/tractor drive of the web feeder component 202 of the input station 100. The other predominant force is created by aerodynamic effects, forces generated from wind resistance against the motion of the web 206. When accelerations are high, the later forces can be enough to break the web 206 at a perforation or cause the tractor pinfeed holes to tear. When high throughput (e.g., in excess of 20,000 cycles per hour) is desired, the acceleration forces on the tractor pin holes and the aerodynamically induced forces on the web 206 become a limiting factor to the obtainable cycle rate. It is further noted that these forces on the web 206 are significantly greater at system startup when the web 206 comes to motion from rest. Once the feed “rhythm” is established, the “dances” in air and creates a “buffer” loop of web 206 in the air to absorb acceleration induced shocks to the web 206. However, before this feed rhythm is established, the web is extremely vulnerable to breakage due to the initial startup forces of the sheet cutter as explained above.

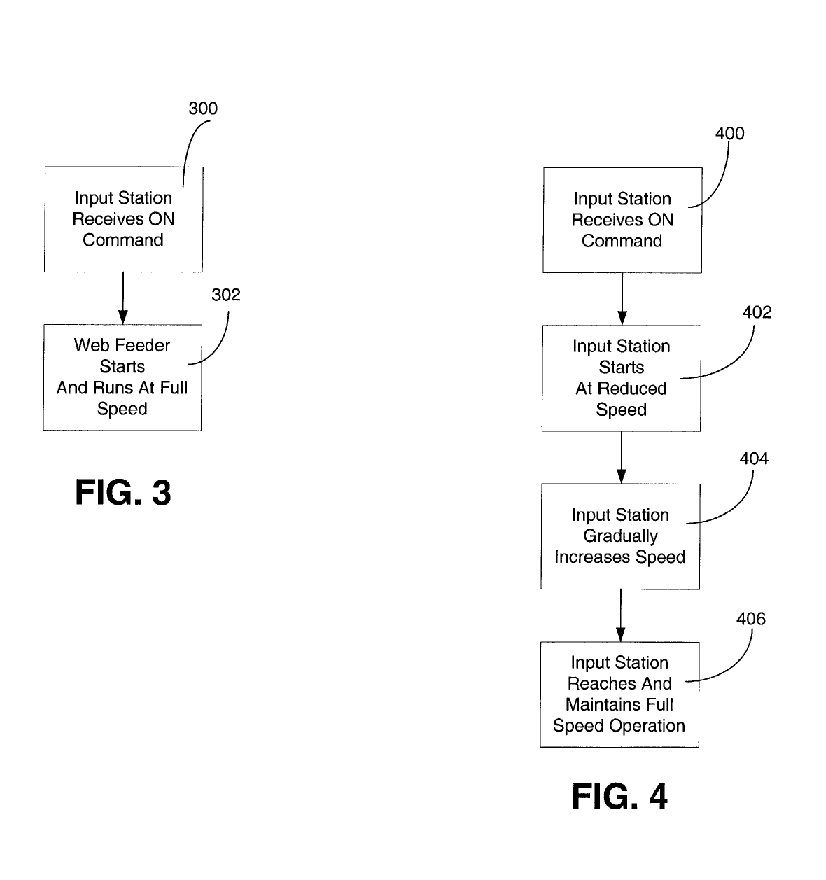

In order to mitigate this likelihood of web breakage during startup of the input station 100, and in accordance with the present invention, the input station 100 is now operative during initial startup to gradually reach its full operational speed. As mentioned above, in the prior art (and with reference to FIG. 3) when input station 100 initial receives its ON command (step 300) the web-feeding component 202 would then be caused to startup at its full speed (step 302) making the input station prone to web breakage as explained above.

In accordance with the present invention, and as illustrated in the flow chart of FIG. 4, when the input station 100 now receives an ON command from the control system (step 400) the web feeding component 202 of the input station 100 starts at a reduced speed (step 402) which is a percentage of the full operational speed of the web feeding component 202. Preferably, this percentage is around 60% of the full operational speed of the web-feeding component 204. The web feeding component 202, during a prescribed amount of time, gradually increases its speed from the reduced initial speed of step 402 to its full operational speed (step 404). Once the web feeding component 202 reaches it full speed, it maintains this speed for continued operation thereof (step 406).

Thus an advantage of this gradual method for start-up of the input station 100 is that it will not impart the significant acceleration and aerodynamic forces on the web 206 subjecting it to breakage during initial start-up of the input station 100. Rather, during startup of the input station 100, reduced acceleration and aerodynamic forces are imparted on the web 206 in order to mitigate the likelihood of web breakage during this initial startup. Perferably, the initial speed of the input station is preferably 60% of its full speed but this initial speed may be prescribed by a user to be any fractional amount of its full operational speed. Further, the acceleration of the operating speed of the input station 100 can also be adjusted by a user such that the time period between the initial speed and the full speed is also controllable by a user.

In summary, a sheet input station for an inserter system having a gradual startup has been described. Although the present invention has been described with emphasis on particular embodiments, it should be understood that the figures are for illustration of the exemplary embodiment of the invention and should not be taken as limitations or thought to be the only means of carrying out the invention. Further, it is contemplated that many changes and modifications may be made to the invention without departing from the scope and spirit of the invention as disclosed.

What is claimed is:

1. A method for operating an input sheet feeder coupled to an inserter system comprising the steps of:
providing an inserter system having a control system coupled to a sheet input station, wherein the sheet input station is coupled to a supply of continuous formed web;
receiving a start command in the sheet input station to start operation of the sheet input station;
starting the sheet input station at an initial speed that is a fraction of its full operational speed; and
gradually increasing the operational speed of the sheet input station from said initial speed to said full speed over a predetermined amount of time.

2. A method for operating an input sheet feeder coupled to an inserter system as recited in claim 1 further including the step of prescribing the initial speed to be 60% of said full operational speed.

3. A method of operating an input sheet feeder coupled to an inserter system as recited in claim 1 further including the step of having a user prescribe the initial speed prior to starting the sheet input station.

4. A method of operating an input sheet feeder coupled to an inserter system as recited in claim 1 further including the step of controlling the acceleration of speed of the input sheet feeder between the initial speed and the full operational speed in dependence upon the full operational speed.

5. A method of operating an input sheet feeder coupled to an inserter system as recited in claim 1 wherein the time period required for the input sheet feeder to reach the full operational speed from the initial speed is fixed.
